(19) United States
(12) Patent Application Publication
(10) Pub. No.: US 2015/0041441 A1
(43) Pub. Date: Feb. 12, 2015

(54) System and Method for Weld Removal, Cutting, and Gouging With Vacuum Removal of Byproducts

(71) Applicant: Charles Klangos, Lowell, MA (US)

(72) Inventor: Charles Klangos, Lowell, MA (US)

(21) Appl. No.: 14/524,273

(22) Filed: Oct. 27, 2014

Related U.S. Application Data
(63) Continuation-in-part of application No. 14/059,648, filed on Oct. 22, 2013, now Pat. No. 8,872,056.
Application No. 14/059,648 is a continuation of application No. 12/468,665, filed on May 19, 2009, now Pat. No. 8,592,710.
(60) Provisional application No. 61/054,375, filed on May 19, 2008.
(60) Provisional application No. 61/944,024, filed on Feb. 24, 2014.

(51) Int. Cl. B23K 9/32; B23K 9/167

(52) U.S. Cl. CPC B23K 9/325; B23K 9/321; B23K 9/167
USPC 219/75; 219/72

(57) ABSTRACT

A system and method for metalworking using a vacuum to evacuate particulate matter, smoke, excess gas, and molten metal from a work area. The vacuum system has a vacuum head and a vacuum nozzle. A bracket establishes pivotal and slidable couplings between the welding head and the vacuum head. The vacuum nozzle has a support surface for being rested on a surface of a workpiece to support the vacuum head and the welding head. A flow of liquid can be applied to the work area defined by the vacuum nozzle and the welding head to provide cooling and to prevent deleterious overheating and particulate matter accumulation. A V-shaped canal, potentially with a depression in each face thereof, can communicate across a support surface of the vacuum nozzle.

### RELATED APPLICATIONS

This application is a continuation-in-part of application Ser. No. 14/059,648, filed, Oct. 22, 2013, which was a continuation of application Ser. No. 12/468,665, filed May 19, 2009, now U.S. Pat. No. 8,592,710, which claimed priority to Provisional Application No. 61/054,375, filed May 19, 2008. This application also claims priority to Provisional Application No. 61/944,024, filed Feb. 24, 2014. Each of the foregoing is incorporated herein by reference.

### FIELD OF THE INVENTION

The present invention relates to welding systems and methods. More particularly, disclosed and protected herein are a system and method for weld removal and metal cutting and gouging with the application of a vacuum during operation of a welding apparatus to evacuate particulate matter, smoke, excess gasses, and molten metal from the work area.

### BACKGROUND OF THE INVENTION

Tungsten inert gas (TIG) welding, which can alternatively be referred to as gas tungsten arc welding (GTAW), is an arc welding process wherein a nonconsumable electrode is employed for welding materials together, cutting, and gouging. The weld area is protected from atmospheric contamination by a shielding gas. The shielding gas is typically an inert gas, such as argon. The flow of the shielding gas must be sufficient and consistent to ensure that the gas covers the weld so that impurities in the atmosphere are blocked. A welding power supply produces the energy required for welding, which is conducted across the welding arc through a column of highly ionized gas and metal vapors, which is referred to as a plasma.

The electrode used in TIG welding is commonly made of tungsten or a tungsten alloy since tungsten has the highest melting temperature among pure metals, at 3,422° C. (6,192° F.). Electrodes can have either a clean finish or a ground finish. The diameter of the electrode can vary, such as between approximately 0.5 millimeter and 6.4 millimeters (0.02-0.25 in), and the length of the electrode can range from 75 to 610 millimeters (3-24 in).

Filler metals are used in nearly all TIG welding processes, except in the welding of thin materials. Filler metals can be disposed in rod form and are available with different diameters and are made of a variety of materials. The filler metal can be added to the weld pool manually. Alternatively, some applications employ an automatically fed filler metal, which often is stored on spools or coils.

TIG welding can be used in relation to thick and heavy pieces of metal and relative to light metals, such as aluminum, magnesium, and copper alloys, and thin pieces of stainless steel. TIG welding is advantageous in that the weld can typically be controlled with greater precision. Furthermore, the resulting welds typically demonstrate greater strength and higher quality than those deriving from other welding methods.

However, cutting, gouging, and weld removal using a TIG welding apparatus can be dangerous and can propagate smoke, fumes, and molten and particulate matter throughout the welding area. Flying sparks and droplets of molten metal can cause severe burns and present fire hazards. Additionally, shielding gases used by TIG welders can displace oxygen and lead to asphyxiation. Furthermore, short wavelength ultraviolet light produced by TIG welders can break down ambient air and form dangerous ozone. Still further, heavy welding metals can be taken into the lungs. Even further, poisonous fumes can be created as the heat from the welder vaporizes materials disposed on the work surface.

Prior art inventors have attempted to extract fumes from the welding area by various methods that have left serious needs with respect to the safety and comfort. For example, some welder's simply employ negative air pressure in the welding area as a whole, such as by use of exhaust fans and other methods. Another attempt to remove fumes from the welding area is disclosed in British Patent No. 1,393,561 to the Hobart Brothers Company. Under the teachings of the '561 patent, a fume passageway is incorporated directly within the inner shell of the handle of the welding head. Disadvantageously, the disclosed invention does not appear to enable any adjustment of the relative positions of the welding tip and the fume passageway whereby the effect of the fume passageway seems to be incapable of adjustment. Furthermore, the invention of the '561 patent fails to provide any support to the welding head during the welding process thereby leaving the operator responsible for attempting to maintain a desired distance and control of the welding head in relation to the workpiece.

In light of the foregoing, the present inventor appreciated a need for a system for use with a TIG welder during weld removal, cutting, and gouging that minimizes or eliminates the propagation of smoke, fumes, molten metal, particulate matter, and other harmful byproducts from the work area thereby to protect the welder, bystanders, and the surroundings. With that appreciation, the inventor developed the system and method for weld removal, cutting, and gouging with the removal of byproducts by the application of a vacuum disclosed herein and as is now protected by U.S. Pat. No. 8,592,710 and continuing patent application Ser. No. 14/059,648.

While the invention of the '710 patent provided a leap forward in the art of weld removal, cutting, and gouging, a number of problems have become apparent even in such improved systems and methods. For instance, during the processes of weld removal, cutting, and gouging, molten metals, exceedingly hot gasses, and other heated matter are sought to be evacuated into the inventive vacuum nozzle. However, it has been found that doing so tends to produce an undesirable accumulation of material that can adhere to and damage the inner walls of the nozzle and the vacuum hose material thereby limiting their durability and performance. Moreover, the components of the weld removal, cutting, and gouging system, constantly exposed to high temperature operation, have tended to exhibit short operational lives. Still further, there is a continuing need to improve the efficiency of the removal of molten metal and other gasses and particulate matter from the work area.

### SUMMARY OF THE INVENTION

In view of the foregoing, the present inventor sought to provide a weld removal, cutting, and gouging system and method for using the same that can remove molten metals, hot gasses, and other heated matter with improved efficiency while resisting the accumulation of molten metal on the weld removal, cutting, and gouging apparatuses.

It is a further object of embodiments of the invention to provide a vacuum removal nozzle that operates with greater efficiency in the removal of welds and in cutting and gouging.

Another object of embodiments of the invention is to provide a system and method for weld removal, cutting, and gouging that permits and provides greater durability of system components, including the vacuum nozzle.

Embodiments of the invention continue to have the object of providing a system and method for use with a TIG welding apparatus that evacuates welding byproducts to prevent or limit the emission of the same from the work area.

A related object of embodiments of the invention is to provide a system and method for applying a vacuum during cutting, gouging, and weld removal with a TIG welding apparatus that enhances the safety of the welder and those in the work area.

Another object of the invention is to provide a system and method for applying a vacuum during cutting, gouging, and weld removal with a TIG welding apparatus that reduces the danger, damage, and spread of debris to the area surrounding the work area.

A further object of embodiments of the invention is to provide a system and method for applying a vacuum during cutting, gouging, and weld removal with a TIG welding apparatus that enables the collection and safe disposal of emitted matter.

Still another object of the invention is to provide a vacuum system and method that produces cuts, gouges, and weld removals that are clean, neat, and efficient and that require minimal grinding, smoothing, and other post-processing.

A further object of embodiments of the invention is to provide a vacuum system and method that enables an adjustment of the relative positions of the welding head, the vacuum head, and, potentially, a source of cooling liquid, for optimal performance.

Another object of the embodiments of the invention is to provide a vacuum system and method that provides stable support to the welding head during welding procedures to reduce operator fatigue and to improve welding consistency.

One will appreciate that the foregoing broadly outlines certain goals of the invention to enable a better understanding of the detailed description that follows and to instill a better appreciation of the inventor's contribution to the art. These and further objects and advantages of embodiments of the invention will become obvious not only to one who reviews the present specification and drawings but also to one who has an opportunity to make use of an embodiment of a system for cutting, gouging, and weld removal with a TIG welding apparatus with the vacuum removal of molten metal, fumes, and other byproducts disclosed herein.

The accomplishment of each of the foregoing objects in a single embodiment of the invention may be possible and indeed preferred. However, it will be appreciated that not all embodiments will seek or need to accomplish each and every potential object and advantage. Nonetheless, all such embodiments should be considered within the scope of the present invention.

In carrying forth the foregoing objects, a basic embodiment of the present invention comprises a metalworking system that enables the application of a vacuum during operation of a TIG welding arrangement to evacuate particulate matter, smoke, excess gasses, and molten metal from a work area. The system has a tungsten inert gas (TIG) welding arrangement with a welding head, an electrode holder retained by the welding head, a nonconsumable tungsten electrode retained by the electrode holder for creating a welding arc, a welding power supply connected to the welding head, and an inert gas supply for providing shielding gas during a metalworking operation. A vacuum system with a vacuum head and a vacuum nozzle retained by the vacuum head is coupled to the welding head by a mounting bracket arrangement.

The mounting bracket arrangement can include a means for permitting an adjustment of a disposition of the welding head in relation to the vacuum head. More particularly, the distance between the tungsten electrode of the welding head and the vacuum nozzle of the vacuum system can be adjustable, such as by a pivotal connection, to enable optimal performance and operator comfort. In certain embodiments, the means for permitting an adjustment of the disposition of the welding head in relation to the vacuum head permits longitudinal and lateral adjustment of the welding head relative to the vacuum head.

A ring with a setscrew or other means of the mounting bracket arrangement can matingly engage the welding head to establish a relatively slidable coupling between the welding head and the vacuum head. Still further, a slidable connection can be established by further established by a link in the mounting bracket arrangement that can have a channel in combination with a fastener slidably engaged with the channel for selectively fixing the fastener in relation to the channel.

Even more particularly, the mounting bracket arrangement can have the support ring, a means for fixing the support ring relative to the welding head, a ring bracket that projects from the support ring, a link pivotally coupled to the ring bracket by a clamping fastener that can selectively lock the ring bracket in relation to the link, a vacuum head bracket that projects from the vacuum head, a channel that communicates longitudinally along the link, and a clamping fastener that passes through the vacuum head bracket and through the channel.

Under certain constructions of the invention, the vacuum nozzle can have a support surface for being rested on a surface of a workpiece so that the vacuum nozzle can provide support to the vacuum head and the welding head. Furthermore, the height of the tungsten electrode above the surface of the workpiece can be adjusted by use of the means for permitting an adjustment of a disposition of the welding head in relation to the vacuum head. To facilitate the evacuation of fumes and debris from the work area, the nozzle tip can have a base bevel surface disposed at an angle relative to a longitudinal axis of the vacuum nozzle that forms the support surface, an opposed suction bevel surface disposed at an angle opposed to the angle of the base bevel surface, and a nozzle aperture with at least a portion of the nozzle aperture interposed along the opposed suction bevel surface. The vacuum nozzle can be formed in potential embodiments of sapphire gemstone or a zirconium alloy for their preferred thermal performance characteristics.

A source of negative air pressure can be connected to the vacuum head by a conduit. Furthermore, a cooling and retention chamber can be interposed between the vacuum head and the source of negative air pressure for receiving particulate matter and other debris. The cooling and retention chamber can comprise a fluid-tight chamber for retaining a volume of cooling fluid, an inlet port connected to the vacuum head, an exhaust port connected to the source of negative pressure, and at least one baffle between the inlet port and the outlet port. To enable an adjustment of the vacuum force applied by the vacuum head, a vacuum control assembly with a pressure gauge and a control valve can be fluidically coupled to the conduit.

The invention can be further characterized as a method for metalworking with the application of a vacuum during operation of a welding arrangement to evacuate particulate matter, smoke, gas, and molten metal from a work area. The method is founded on providing a welding arrangement, such as tungsten inert gas (TIG) welding arrangement, with a welding head, an electrode holder retained by the welding head, an electrode retained by the electrode holder for creating a welding arc, and a welding power supply connected to the welding head. A vacuum system is provided with a vacuum head and a vacuum nozzle retained by the vacuum head. The vacuum nozzle has a support surface for being rested on a surface of a workpiece during weld removal, cutting, and gouging. An adjustable mounting bracket couples the welding head to the vacuum head and is adjustable to permit an adjustment of a disposition of the welding head in relation to the vacuum head and an adjustment of a distance between the electrode of the welding head and the vacuum nozzle of the vacuum system. The support surface of the vacuum nozzle can thus be disposed on the surface of the workpiece to cause the vacuum nozzle to provide support to the vacuum head and the welding head.

Under this configuration, cutting, gouging, and weld removal can be carried out by actuating the electrode of the welding arrangement while evacuating particulate matter, smoke, gas, and molten metal through the vacuum nozzle by actuating the vacuum system. Except as the invention might be expressly limited, the vacuum nozzle and welding head can be retained and advanced manually, such as in the hands of a user, or automatically.

Advantageously, the system permits a user to adjust the performance of the vacuum system, the welding head, and the overall metalworking system. For instance, a user can adjust the height and supported position of the electrode above the surface of the workpiece and the distance between the electrode and the vacuum nozzle by use of the adjustable mounting bracket.

The adjustable mounting bracket can again permit longitudinal and lateral adjustment of the welding head relative to the vacuum head. Moreover, the adjustable mounting bracket can establish a pivotal and relatively slidable coupling between the welding head and the vacuum head. A user exploiting those longitudinal, lateral, pivotal, and slidable adjustments can optimize the performance of the vacuum nozzle, the welding head, and the combination of their effects in performing metalworking processes with the efficient removal of gas, particulate matter, debris, and molten metal.

The vacuum nozzle can again have a tip with a base bevel surface disposed at an angle relative to a longitudinal axis of the vacuum nozzle that forms the support surface and a suction bevel surface disposed at an angle opposed to the angle of the base bevel surface. With that, the suction bevel surface will be upturned from the support surface and the work surface. A nozzle aperture can have at least a portion thereof interposed along the suction bevel surface.

In a still further manifestation of the invention, the metalworking system can again incorporate a welding system with a welding head, an electrode holder retained by the welding head, an electrode retained by the electrode holder for creating a welding arc, and a welding power supply connected to the welding head. A vacuum system can have a vacuum head, and a mounting bracket can couple the welding head to the vacuum head. The mounting bracket can be adjustable to permit an adjustment of a disposition of the welding head in relation to the vacuum head, and a liquid dispensing system can be retained to dispense liquid into the work area. Under even this basic embodiment, the liquid dispensed into the work area can cool the metalworking system and prevent the undesirable accumulation of particulate matter.

The vacuum system can include a vacuum nozzle retained by the vacuum head. The vacuum nozzle can have a nozzle aperture and a support surface for being rested on a surface of a workpiece during weld removal, cutting, and gouging. With that, the vacuum nozzle can provide support to the vacuum head and the welding head. Moreover, a height and supported position of the electrode above the surface of the workpiece can be adjusted by use of the mounting bracket to adjust a disposition of the welding head in relation to the vacuum head. Where a vacuum nozzle is included, it can have inner annular wall surface that tapers toward a distal end of the vacuum nozzle. A source of negative air pressure can be connected to the vacuum head by a conduit.

In particular embodiments of the metalworking system, the liquid dispensing system comprises a liquid dispensing nozzle retained to dispense liquid into the work area. A reservoir with an open inner volume can be incorporated for retaining a volume of liquid. Where provided, the reservoir is in fluidic communication with the liquid dispensing nozzle. The liquid dispensing nozzle can be adjustable in position relative to the work area.

It is further contemplated that the liquid dispensing system can include a mist generator operative to create a mist from supplied liquid, such as liquid received from a reservoir with an open inner volume for retaining the volume of liquid. The mist generator can, for example, be carried forth by a Venturi tube operative to generate a mist from liquid under the Venturi effect. Further, a compressed air source can supply compressed air to the mist generator.

Where a vacuum nozzle is retained by the vacuum head, it can have a peripheral wall with an outer wall surface, an inner wall surface, a nozzle aperture at least partially defined by the inner wall surface, and a support surface for being rested on a surface of a workpiece during weld removal, cutting, and gouging. A canal can be disposed in the support surface. For example, the canal can communicate from a first end open to the outer wall surface of the peripheral wall to a second end open to the inner wall surface of the peripheral wall. In certain embodiments, the canal can have a V-shape with first and second canal faces. Further, at least one depression can be disposed in at least one of the canal faces, and it is contemplated that a depression can be disposed in each of the first and second canal faces.

Embodiments of the invention can be further characterized as a method for metalworking with a supply of liquid and an application of a vacuum during operation of a welding arrangement to evacuate particulate matter, smoke, gas, and molten metal from a work area. In carrying forth the method, one can provide a welding system with a welding head, an electrode holder retained by the welding head, an electrode retained by the electrode holder for creating a welding arc, and a welding power supply connected to the welding head, a vacuum system with a vacuum head, a mounting bracket for coupling the welding head to the vacuum head wherein the mounting bracket is adjustable to permit an adjustment of a disposition of the welding head in relation to the vacuum head, and a liquid dispensing system retained to dispense liquid into the work area. With such components provided, the vacuum head and the welding head can be disposed on or in proximity to the workpiece. Cutting, gouging, or removing welding from the workpiece can be carried out by actuating the electrode of the welding arrangement while evacuating particulate matter, smoke, gas, and molten metal through the vacuum nozzle by actuating the vacuum system. Liquid can be dispensed to the work area defined by the vacuum nozzle and the welding head. While it need not necessarily be, the welding system can comprise a tungsten inert gas (TIG) welding system with a nonconsumable tungsten electrode and an inert gas supply for providing shielding gas during metalworking.

Where the vacuum system further comprises a vacuum nozzle retained by the vacuum head and wherein the vacuum nozzle has a nozzle aperture and a support surface, a further step can be carried out by resting the support surface on a surface of a workpiece during weld removal, cutting, and gouging whereby the vacuum nozzle provides support to the vacuum head and the welding head and whereby a height and supported position of the electrode above the surface of the workpiece can be adjusted by use of the mounting bracket to adjust a disposition of the welding head in relation to the vacuum head.

The step of dispensing liquid can comprise dispensing liquid from the dispensing nozzle. The step of dispensing liquid from the dispensing nozzle can include receiving liquid from the reservoir. The liquid dispensing system can include a mist generator operative to create a mist from supplied liquid, and the step of dispensing liquid can comprise dispensing liquid at least partially in mist form.

One will appreciate that the foregoing discussion broadly outlines the more important features of the invention to enable a better understanding of the detailed description that follows and to instill a better appreciation of the inventor's contribution to the art. Before any particular embodiment or aspect thereof is explained in detail, it must be made clear that the following details of construction and illustrations of inventive concepts are mere examples of the many possible manifestations of the invention.

### BRIEF DESCRIPTION OF THE DRAWINGS

The invention may be more completely understood with reference to the accompanying drawings, in which:

FIG. 1 is a view in side elevation of a TIG welding apparatus according to the prior art;

FIG. 2 is a partially sectioned perspective view of a prior art TIG welding apparatus;

FIG. 3 is a perspective view of a vacuum system for use with a welding apparatus during cutting, gouging, and weld removal as disclosed herein;

FIG. 4A is a perspective view of a welding head with a vacuum nozzle pursuant to the present invention;

FIG. 4B is a partially sectioned close-up perspective view of the welding head and vacuum nozzle of FIG. 4B;

FIG. 5 is a cross-sectional view of a cooling and retention chamber of a vacuum system for use with a welding apparatus as disclosed herein;

FIG. 6 is a partially sectioned perspective view of a portable unit housing a cooling and retention chamber, vacuum motors, and other components under the present invention;

FIG. 7A is an alternative vacuum system according to the invention for use with a welding apparatus during cutting, gouging, and weld removal;

FIG. 7B is an amplified view of the vacuum system of FIG. 7A;

FIG. 8 is a perspective view of a vacuum nozzle according to the invention;

FIG. 9 is a longitudinally sectioned view of the vacuum nozzle taken along the line 9-9 in FIG. 8;

FIG. 10 is a longitudinally sectioned view of the vacuum nozzle taken along the line 10-10 in FIG. 8;

FIG. 11 is an upper perspective view of an alternative nozzle according to the invention disclosed herein; and

FIG. 12 is a cross-sectional view of the nozzle of FIG. 10 taken along a longitudinal direction along the line 12-12 in FIG. 11.

### DETAILED DESCRIPTION OF PREFERRED EMBODIMENTS

It will be appreciated that the present invention for a system and method for cutting, gouging, and weld removal with a TIG welding apparatus with the vacuum removal of molten metal, fumes, and other byproducts disclosed herein is subject to widely varied embodiments. However, to ensure that one skilled in the art will be able to understand and, in appropriate cases, practice the present invention, certain preferred embodiments of the broader invention revealed herein are described below and shown in the accompanying drawing figures. Before any particular embodiment of the invention is explained in detail, it must be made clear that the following details of construction, descriptions of geometry, and illustrations of inventive concepts are mere examples of the many possible manifestations of the invention.

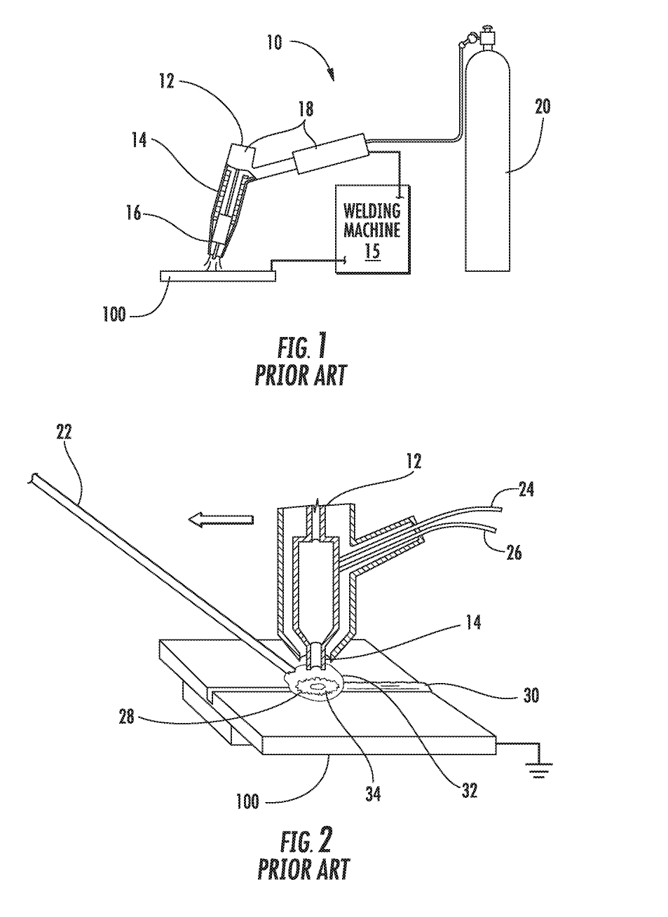

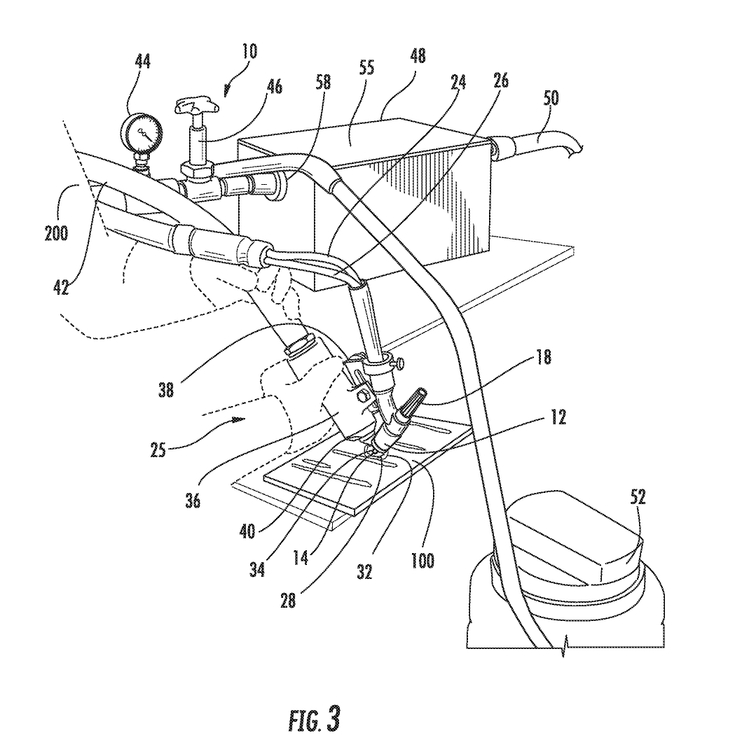

A conventional TIG welding arrangement is indicated generally at 10 in FIG. 1, and FIG. 2 depicts a prior art TIG welding head 12 in operation. The welding head 12 employs a nonconsumable tungsten electrode 14 that is retained by an electrode holder 18. The welding head 12 receives power from a welding power supply 24. Shielding gas 32 is provided by an inert gas supply 20 through a shielding gas supply hose 26. The welding power supply 24 is typically a constant current power source, meaning that the current and thus the heat remain relatively constant, even if the arc distance and voltage change.

In direct current TIG welding with a negatively charged electrode (DCEN), a negatively charged electrode generates heat by emitting electrons. The electrons travel across the arc to cause thermal ionization of the shielding gas thereby yielding an increase in the temperature of the base material. In direct current TIG welding with a positively charged electrode (DCEP), which is not as common, electrons flow oppositely thereby causing the electrode to reach very high temperatures. As the electrons flow toward the electrode, ionized shielding gas flows back toward the base material thereby improving the quality and appearance of the weld by removing oxides and other impurities.

The shielding gas supplied by the shielding gas supply hose 26 is dispensed through gas passages 16 in the welding head 12 to protect the welding area from atmospheric gases, such as nitrogen and oxygen. Otherwise, such gases can cause fusion defects, porosity, and weld metal embrittlement when they make contact with the electrode 14, the arc 28, or the welding metal whether it be the filler rod 22 or the workpiece 100. Shielding gas also contributes to maintaining a stable arc 28 and aids in the transfer of heat from the electrode 14 to the metal of the filler rod 22 and the workpiece 100.

The welding arc 28 is initiated by a high frequency generator 15 that provides a path for the welding current through the shielding gas when the separation between the electrode 14 and the workpiece 100 is within a given range of distance, such as approximately 1.5-3 mm (0.06-0.12 in). Alternatively, the electrode 14 and the workpiece 100 can be brought into contact to initiate what is referred to as a touch or scratch start of the arc 28.

With an arc 28 initiated, the welder typically creates a weld pool 34 by moving the welding head 12 in a small circle. The welding head 12 is then normally tilted to a given angle away from vertical. During each of the processes of welding, weld removal, cutting, and gouging, the welder then attempts to maintain a constant separation between the workpiece 100 and the electrode 14. During welding, filler metal, such as from the filler rod 22, is added as necessary to maintain the weld pool 34 as the welding head 12 leaves a weld bead 30 in its trail. However, during weld removal, cutting, and gouging, material is only removed. Filler metal need not be added.

As noted above, TIG welding employing the prior art welding arrangements 10 depicted in FIGS. 1 and 2 is advantageous for a plurality of reasons including the strength and quality of the resulting welds. However, during the processes of cutting, gouging, and weld removal, TIG welding methods and systems of the prior art suffer from a plurality of disadvantages as previously summarized. For example, they present dangers to the welder, bystanders, and the surroundings resulting from the propagation of smoke, debris, molten metal, fumes, and other welding byproducts.

The present invention advantageously solves these and further deficiencies by providing a specialized system and method for cutting, gouging, and weld removal using a welding apparatus wherein molten metal, fumes, and other byproducts are removed by the application of a vacuum. The welding apparatus can be a TIG welding apparatus as may be referenced herein, but the welding apparatus should not be considered so limited except as expressly required by the claims.

In any event, an exemplary embodiment of the current invention for a system for the vacuum removal of byproducts during cutting, gouging, and weld removal relative to a welding system is indicated generally at 10 in FIG. 3 where the welding system comprises a TIG welding apparatus. As shown in FIG. 3, the system 10 is founded on a welding head 12 and an adjustable vacuum and support system 25, which may alternatively be referred to as a vacuum system 25, with a vacuum head 36. The adjustable vacuum and support system 25 has a longitudinally and laterally adjustable bracket arrangement 38 that retains and supports the welding head 12. As will be described further hereinbelow, through the longitudinal and lateral adjustability, the bracket arrangement 38 acts as a means for enabling an adjustment of the relative orientations and positions of welding head 12 and the vacuum head 36 and an adjustment of the supported position of the welding head 12 relative to the workpiece 100.

Where the welding apparatus comprises a TIG welding apparatus, the welding head 12 can be substantially according to the prior art with a tungsten electrode 14 retained by an electrode holder 18. Indeed, in certain practices of the invention, the adjustable vacuum and support system 25 can be retrofitted to a prior art welding head 12 to enable the use thereof according to the present invention. Alternatively, the welding head 12 and the vacuum and support system 25 can be integrated on initial manufacture or otherwise for use under the present invention. A power supply 24 enables the creation of a welding arc 28, which is used under the present invention for weld removal, cutting, and gouging. As with prior art welding heads 12, a shielding gas supply hose 26 supplies shielding gas 32 for protecting a weld pool 34.

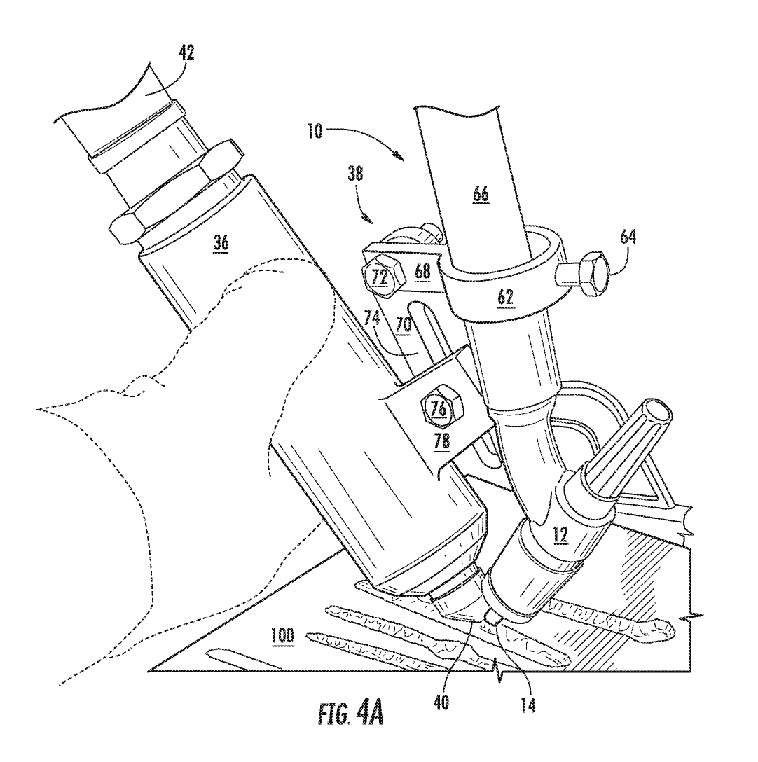

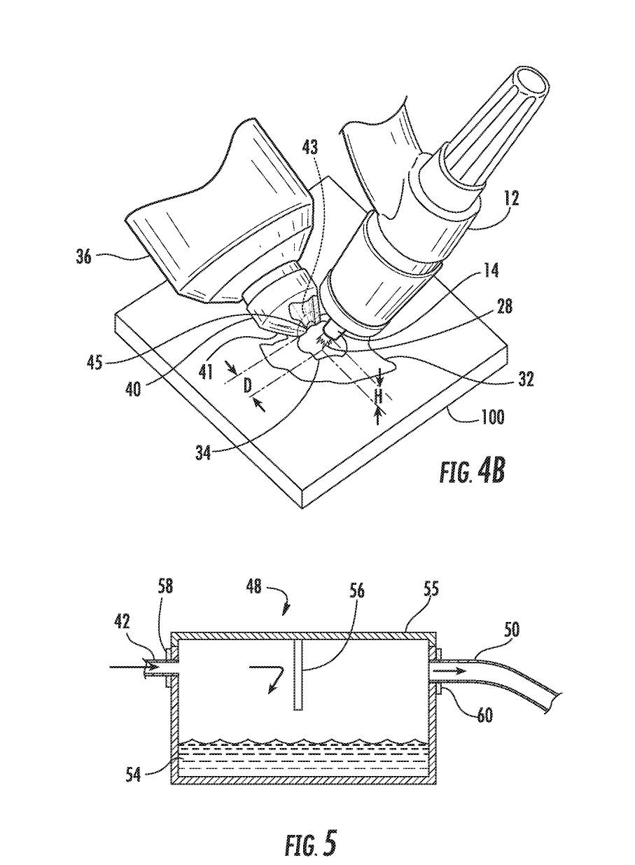

As shown in FIGS. 3, 4A, and 4B, the welding head 12 is coupled by the mounting bracket arrangement 38 to the vacuum head 36, which has a vacuum nozzle 40. The mounting bracket arrangement 38 is adjustable to enable a selective adjustment of the distance and orientation of the vacuum nozzle 40 in relation to the welding head 12 in general and the tungsten electrode 14 in particular. Furthermore, where the tip of the vacuum nozzle 40 is placed in a supportive position on the surface of the workpiece 100, the mounting bracket arrangement 38 additionally permits an adjustment of the height of the electrode 14 above the workpiece 100.

A source of negative pressure, in this case a vacuum 52, provides a suction force to the vacuum nozzle 40 through an inlet vacuum conduit 42, a cooling and retention chamber 48, and an outlet vacuum conduit 50, which are in fluidic communication with one another. With this, byproducts of the cutting, gouging, and weld removal processes, including smoke, fumes, and particulate matter, can be evacuated to prevent the propagation of the same throughout the work area.

A vacuum control assembly is operably associated with the inlet vacuum conduit 42, such as by being interposed therealong, to enable a control over the vacuum pressure applied at the vacuum nozzle 40. In the present embodiment, as depicted in FIG. 3, the vacuum control assembly comprises a pressure gauge 44 in combination with a control valve 46. So arranged, the vacuum control assembly formed by the pressure gauge 44 and the control valve 46 can be employed in cooperation with the adjustability provided by the mounting bracket arrangement 38 to ensure that sufficient vacuum force is applied to prevent or minimize the propagation of byproducts from cutting, gouging, and weld removal throughout the work area while ensuring that not so much vacuum force is applied as to impair the protective function of the shielding gas 32.

In one presently contemplated embodiment, the vacuum head 36 can be founded on a metal cylinder, which could be crafted from an aluminum alloy. The cylinder can have a length of approximately ten inches, an outer diameter of 1.5 inches, and an inner diameter of approximately ⅞ inches. In one embodiment, for example, the vacuum nozzle 40 could have a length of approximately 2 inches and an outer diameter of approximately 1.25 inches. As seen in FIG. 4B, the nozzle 40 can have a distal end cut to first and second opposed bevel angles to form a downwardly-turned base bevel surface 41 and an upwardly-turned suction bevel surface 43. A nozzle aperture 45 has at least a portion thereof interposed along the upwardly-turned suction bevel surface 43 and a portion thereof interposed along the downwardly-turned base bevel surface 41 to facilitate the efficient intake of the byproducts of weld removal, cutting, and gouging. Under this construction, the system 10 can be employed in cutting, gouging, and weld removal with the base bevel surface 41 resting on the surface of the workpiece 100 as shown in FIGS. 3, 4A, and 4B. As such, the base bevel surface 41 provides support to the welding head 12 and the adjustable vacuum and support system 25 thereby reducing operator fatigue, improving control over the disposition of the welding head 12 relative to the work surface 100, and, as a result, improving the quality of the welding process.

To prevent clogging, the nozzle 40 and the inner annular wall thereof can taper toward the distal end of the nozzle 40. By way one non-limiting embodiment, the nozzle 40 could taper from a proximal outer diameter of approximately 7/16 inches to an outer diameter at its distal tip of approximately ⅜ inches. The vacuum nozzle 40 can be formed integrally with or separately from the vacuum head 36 and can be formed from any suitable material or combination thereof. In certain embodiments, the vacuum nozzle 40 can be crafted from a high-melting point aluminum alloy. In other embodiments, the vacuum nozzle 40 can be formed from a precious or semi-precious gemstone for improved performance and durability. For example, in one contemplated embodiment, the vacuum nozzle 40 can be crafted from sapphire gemstone, which may be considered particularly advantageous in carrying forth the invention. In other embodiments, the vacuum nozzle 40 can be formed from a zirconium alloy for its excellent resistance to heat and other advantageous properties. Such a vacuum nozzle 40 could, for example, have an outer diameter of approximately ⅞ inches with a ⅝ inch aperture.

The vacuum conduit 42 could pursue any effective configuration. In certain constructions, the vacuum conduit 42 can comprise a hose lined with braided stainless steel with a first, distal end coupled to the vacuum head 36 and a second, proximal end fluidically coupled to the cooling and retention chamber 48 with the pressure gauge 44 and the control valve 46 of the vacuum control assembly interposed therebetween. The pressure gauge 44 and the control valve 46 can be separate or unified and can be fluidically coupled to the cooling and retention chamber 48 at an inlet coupling 58. The dimensional characteristics of the vacuum conduit 42 can vary depending on the circumstances. In one embodiment, for example, the conduit 42 can have a 1-inch diameter and a length of approximately 3 feet.

The cooling and retention chamber 48 can comprise a rigid box of metal or other suitable material. In certain embodiments, the chamber 48 can be formed with walls of ⅛ inch thick sheet metal with a length of approximately two feet and a height and width of approximately 1 foot. The chamber 48 can have a removable lid 55 for enabling access to the inner volume thereof. An outlet vacuum conduit 50 has a first end fluidically coupled to the chamber 48 at an outlet coupling 60 and a second end fluidically coupled to the vacuum source 52 of FIG. 3.

The cooling and retention chamber 48, which is depicted in cross section in FIG. 5, retains a volume of cooling fluid 54. One or more downwardly depending baffles 56 can be fixed to the removable lid 55 and interposed within the open inner volume of the retention chamber 48 between the inlet vacuum conduit 42 and the outlet vacuum conduit 50. Under this construction, particulate matter and molten metal drawn from the work area through the vacuum nozzle 40 is pulled through the inlet vacuum conduit 42 and into the cooling and retention chamber 48. Once in the retention chamber 48, the particulate matter either falls immediately into the cooling fluid 54 for any necessary cooling or, if possessing sufficient velocity, strikes the baffle 56 and then falls into the cooling fluid 54 where it is cooled and retained for later disposal. When necessary, the lid 55 can be removed from the chamber 48 to clear accumulated material, to clean the inner surfaces of the chamber 48, or otherwise to maintain the chamber 48.

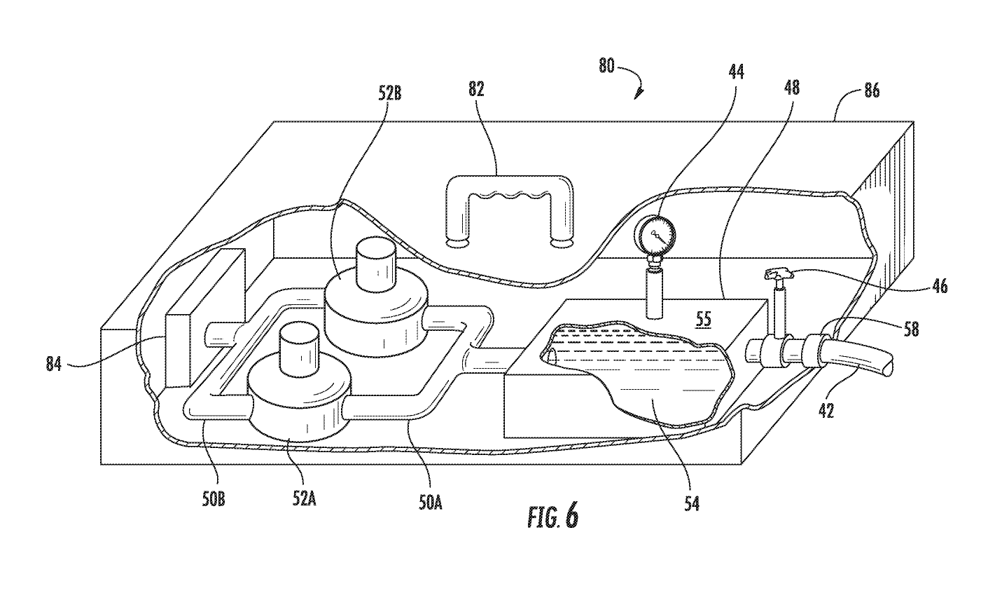

Embodiments of the invention are also contemplated where many of the components are integrated into a unitary, portable unit as shown at 80 in FIG. 6. There, a housing 86, which comprises a rigid box with an open inner volume, houses the cooling and retention chamber 48, which again has a removable lid 55. The inlet vacuum conduit 42 can be coupled to the inlet coupling port 58. Pressure in the cooling and retention chamber 48 and the system in general can be monitored by a gauge 44 and controlled by a valve 46. A first outlet vacuum conduit 50A has a proximal end coupled to the cooling and retention chamber 48 and first and second branches fluidically coupled to first and second vacuum motors 52A and 52B. A second outlet vacuum conduit 50B has first and second branches fluidically coupled to the first and second vacuum motors 52A and 52B and a distal end fluidically coupled to a filtration unit 84, which can include a chromium filter, for cleansing air received from the vacuum motors 52A and 52B. A handle 82 is fixed to the housing 86 for enabling lifting and carrying of the portable unit 80. With this, the portable unit 80 can be connected to a vacuum head 36 as disclosed herein, and the vacuum head 36 can in turn be coupled to a welding head 12 for removing smoke, fumes, and debris as disclosed herein in a readily portable format.

To make use of the system 10 for cutting, gouging, and weld removal with a welding apparatus 10, the welder 200 can position and align the welding head 12 in relation to the vacuum head 36, which will also control the position that the welding head 12 is retained relative to the workpiece 100, by manipulation of the bracket arrangement 38. As shown in FIG. 4A where the vacuum head 36 and the bracket arrangement 38 forming the adjustable vacuum and support system 25 support a welding head 12 typical of the prior art, the bracket arrangement 38 includes a support ring 62 that matingly receives the handle portion 66 of the welding head 12. A setscrew 64 can lock the support ring 62 at a desired location along the handle portion 66. A ring bracket 68 projects radially from the support ring 62, and a link 70 is pivotally coupled to the ring bracket 68 by a clamping fastener 72 that can selectively lock the ring bracket 68 in relation to the link 70. A vacuum head bracket 78 projects radially from the vacuum head 36. The link 70 has a channel 74 that communicates longitudinally therealong, and a clamping fastener 76 passes through the vacuum head bracket 78 and through the channel 74. With this, the vacuum head bracket 78 can be adjusted and selectively locked in angular and longitudinal positions relative to the link 70.

So configured, the bracket arrangement 38 can be exploited to adjust the relative orientations and positions of welding head 12 and the vacuum head 36 and to adjust the supported position of the welding head 12 relative to the workpiece 100. The longitudinal position of the support ring 62 and the angular relationships and longitudinal positions of the brackets 68 and 78 and the link 70 can all be adjusted for optimal performance of the system 10. By way of example, the distance D between the nozzle aperture 45 and the arc 28 can be adjusted to optimize the vacuuming effect in the removal of smoke and debris. Furthermore, the height H at which the electrode 14 is supported relative to the surface of the workpiece 100 as the vacuum nozzle 40 is stably supported by the workpiece 100 can be adjusted for optimal cutting, gouging, weld removal, or other operations. Furthermore, the relative positions of the vacuum head 36 and the welding head 12 can be adjusted for the comfort of the welder 200 and based on the characteristics of, for example, the welding head 12 and the welding operation.

With the vacuum head 36 and the welding head 12 positioned as desired, the vacuum 52 can be activated and the welding head 12 can be ignited. These activations can be independent or interdependent. The welding head 12 and vacuum head 36 can be positioned in relation to the workpiece 100 to enable weld removal, cutting, or gouging. As the process is carried out, the vacuum nozzle 40 forcibly draws the molten metal, gases, and particulate matter from the work area thereby preventing the contamination of the surrounding area and minimizing dangers to the welder 200, bystanders, and the surroundings.

The weld removal, cutting, and gouging system 10 disclosed above is believed to have provided a leap forward in the art of weld removal, cutting, and gouging. Nonetheless, a number of problems have become apparent even in such improved systems and methods. For instance, the molten metal and the exceedingly hot gasses and other heated matter sought to be evacuated into the inventive vacuum nozzle tend to produce an undesirable accumulation of material that can adhere to and damage the inner walls of the nozzle and the vacuum hose material thereby limiting their durability and performance. Further, the components of the weld removal, cutting, and gouging system have tended to exhibit short operational lives due to their constant exposure to high temperature operation.

Knowing these needs, the present inventor sought to improve upon the weld removal, cutting, and gouging system and method for using the same to permit the removal of molten metals, hot gasses, and other heated matter with improved efficiency while resisting the accumulation of molten metal on the weld removal, cutting, and gouging apparatuses. He also sought to develop a vacuum removal nozzle that operates with greater efficiency in the removal of welds and in cutting and gouging and to provide system components that demonstrate greater durability and longevity of use.

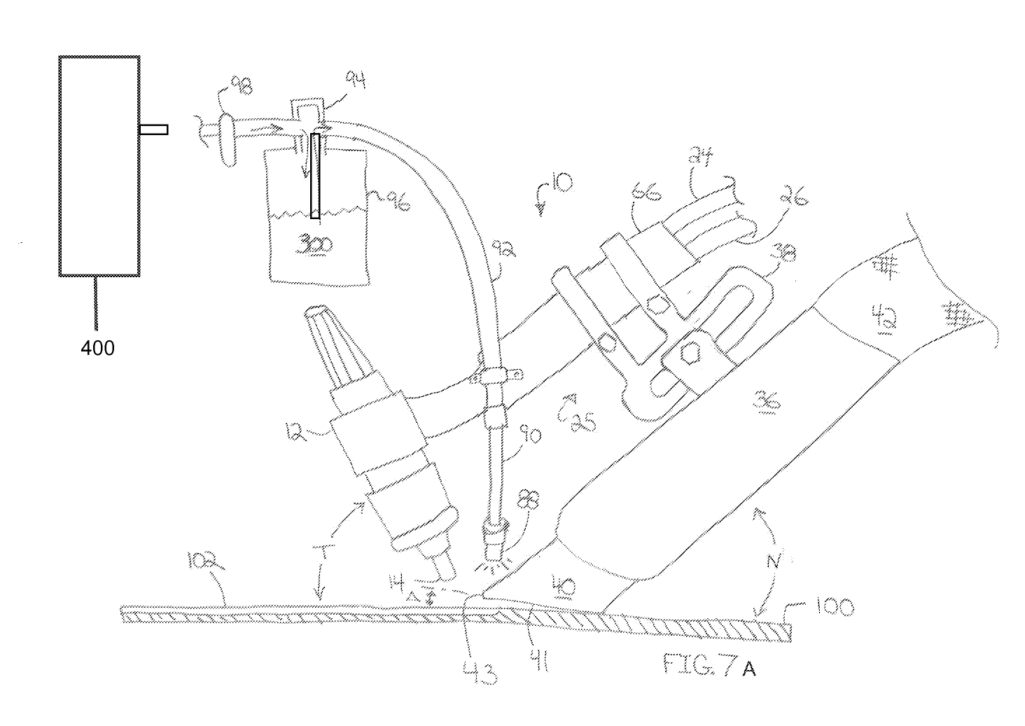

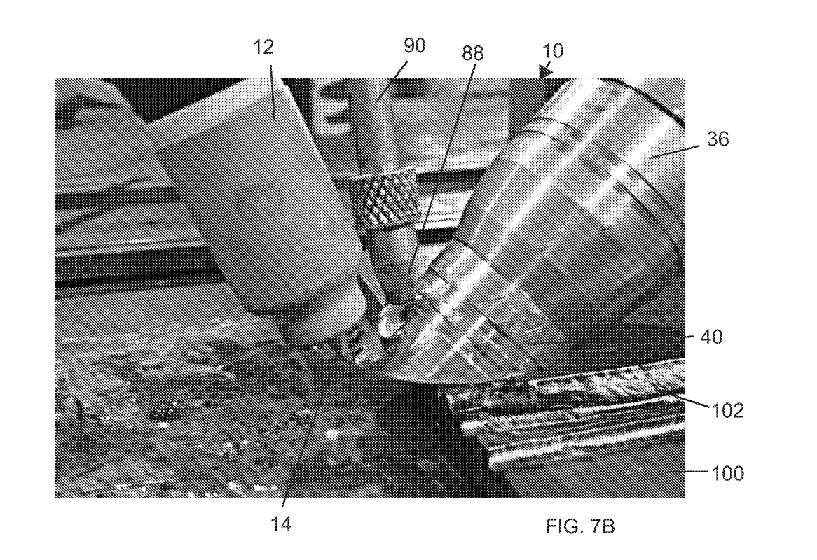

While many options seeking to provide the foregoing improvements were contemplated and explored, remarkable and surprising improvements were realized when the modified weld removal, gouging, and cutting system 10 of FIGS. 7A and 7B was implemented. There, the system 10 again has a welding head 12 and an adjustable vacuum and support system 25 with a vacuum head 36. The adjustable vacuum and support system 25 has a longitudinally, laterally, and angularly adjustable bracket arrangement 38 that retains and supports the welding head 12. Through that longitudinal, lateral, and angular adjustability, the bracket arrangement 38 permits adjustment of the relative orientations and positions of the welding head 12 and the vacuum head 36 and an adjustment of the supported position of the welding head 12 relative to the workpiece 100. As before, a source of negative pressure, again a vacuum 52, provides a suction force to the vacuum nozzle 40 through an inlet vacuum conduit 42.

The welding head 12, which again could be a TIG welding head or potentially another type of welding head, can be substantially according to the prior art. Where the welding head 12 comprises a TIG welding head, it can have a tungsten electrode 14 retained by an electrode holder 18. A power supply 24 enables the creation of a welding arc 28, and a shielding gas supply hose 26 supplies shielding gas for protecting a weld pool.

Here, however, the system 10 is modified by, among other things, the introduction of a liquid mist incident to the work area established by the welding head 12 and the vacuum nozzle 40 by a liquid supply and dispensing system. While the introduction of liquid and, indeed, the actual fluid so introduced can vary within the scope of the invention, the present system 10 introduces a spray, mist, or other flow of liquid, such as water, into the work area through a misting nozzle 88. The orientation and incident location of the flow from the nozzle 88 can be fixed or adjustable within the scope of the invention. As shown, the misting nozzle 88 can be retained in the area above the vacuum nozzle 40 and flow from the misting nozzle 88 can, for instance, be directed onto the central or distal portion of the vacuum nozzle 40.

Flow to the nozzle 88 can be received through a conduit 90, which could be a rigid conduit, that can in turn receive flow from a supply conduit 92, which could be flexible. The flexible conduit 92 is in fluidic communication with a reservoir 96 that can retain a volume of liquid 300 within an open inner volume thereof. The flexible conduit 92 can, for example, be fluidically coupled with the reservoir 96 through a mist generator 94 operative to create a mist from the liquid 300 in the reservoir 96.

In certain embodiments, the mist generator 94 could incorporate a Venturi tube and could be operative to generate a mist from the liquid 300 under the Venturi effect. The reservoir 96 and the conduit 92 receive compressed air from a compressed air source 400, such as a compressor or a tank, and the flow of air can be controlled by an air regulator 98. Under this configuration, compressed air can draw liquid 300 from the reservoir 96, and the liquid 300 can be dispensed from the misting nozzle 88. An operational pressure of approximately 20 psi for the compressed air has proven to be satisfactory. While such a mist generator 94 may be employed to good advantage, it will be understood that other methods and systems for generating mist could additionally or alternatively be employed. Indeed, it would be possible for the misting nozzle 88 to contribute to the generation of mist or to create substantially all of the mist from supplied liquid.

It has been found that the application of this mist or other flow of liquid, under control by the operator, can cool one or more of the tip 14 of the welding head 12, the nozzle 40, the vacuum head 36, the hose 42, evacuated particulate matter and gasses, and the work piece 100 itself. Where the vacuum nozzle 40, the welding head 12, and the work piece 100 are operating at a typical, elevated operating temperature, the incident liquid 300 can be superheated as it receives heat from the system 10 and the weld removal, cutting, or gouging operation. The heating or superheating of the liquid 300 can potentially liberate free hydrogen as may be determined and substantiated by further research. With this, the gouge 102, weld removal, or cut tends to be still cleaner. Moreover, the components of the system 10 minimize or avoid not only the accumulation of heat but also the deleterious accumulation of molten metal and damage from hot particulate matter and gasses. Galling of the work piece 100 is prevented. Longer operating times are permitted, and nozzles 40 are prevented from rapid burnout as can be experienced without the application of the cooling flow of liquid as taught herein.

The liquid 300 can vary within the scope of the invention. In certain practices, the liquid 300 can be water. Other practices of the invention can exploit other liquids and liquid solutions depending on, among other things, external environmental conditions, the construction of the components of the system 10, and characteristics of the work piece 100. For instance, where weld removal, cutting, or gouging is to be undertaken in a sub-freezing environment, the liquid 300 can be an antifreeze liquid of any suitable type. By way of example, a solution of ammonia and water or ammonia, alcohol, and water as would be found in a basic window washing liquid could be employed.

As shown in FIGS. 7A and 7B, the vacuum nozzle 40 can be disposed with a portion thereof resting on a work surface 100 during weld removal, during cutting, or during the creation of a gouge 102. The system 10 can be used under the method previously described with the addition of dispensing liquid 300, such as liquid in mist form, from the dispensing misting nozzle nozzle 88. The liquid 300 could be dispensed prior to, during, and, additionally or alternatively, after operation of the welding head 12 to produce a cut, gouge, or weld removal.

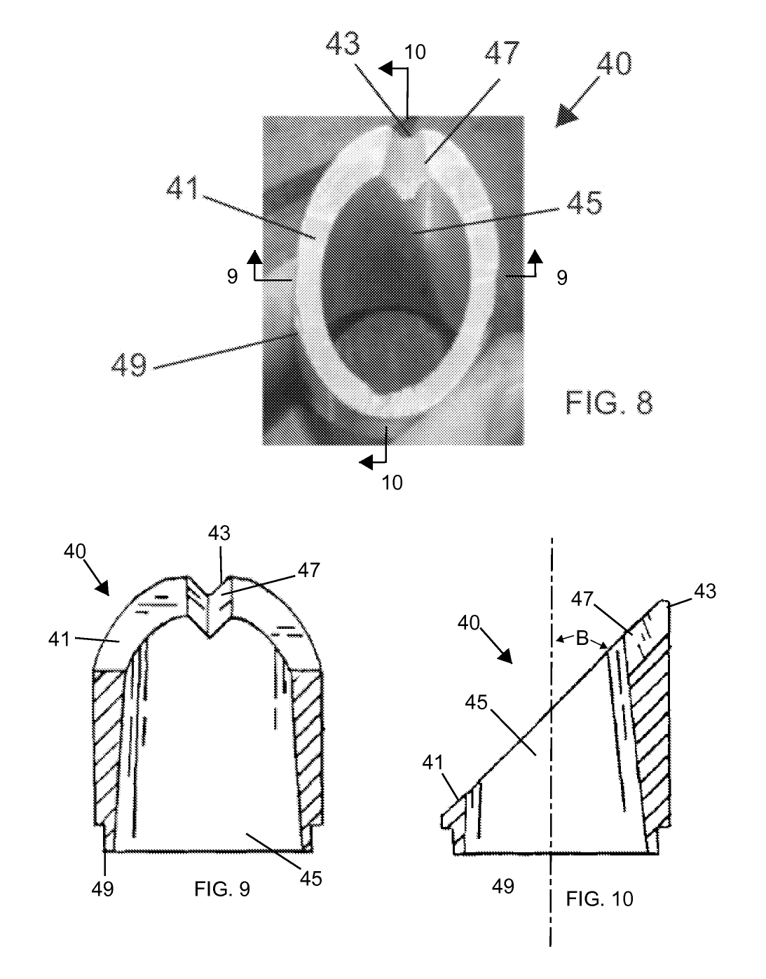

It will be noted that the present embodiment of the system 10 is also modified with respect to the vacuum nozzle 40, which is shown apart from the remainder of the system in FIGS. 8 through 10. By combined reference to FIGS. 7A through 10, one can perceive that the nozzle 40 can have a distal end cut or formed with a downwardly-turned base bevel surface 41 and, potentially, an upwardly-turned suction bevel surface 43. To be clear, however, the suction bevel surface 43 could be minimized or foregone in certain manifestations of the nozzle 40.

As shown in FIG. 10, the base bevel surface 41 is disposed at an angle B with respect to a longitudinal axis of the nozzle 40. In one embodiment, the bevel surface angle B is approximately 45 degrees. With the nozzle 40 so formed, a nozzle aperture 45 is created with an open portion that essentially comprises the open tip of the nozzle 40 to facilitate the intake of the byproducts of weld removal, cutting, and gouging. To prevent clogging, at least the inner surface of the peripheral wall 49 of the nozzle 40 can again taper toward the distal end of the nozzle 40, such as in a frusto-conical pattern. In this example of the nozzle 40, the outer surface of the peripheral wall 49 is cylindrical and of a generally consistent diameter, except for a proximal end portion of the nozzle 40 where the outer surface of the peripheral wall 49 narrows to a reduced diameter at a shoulder for permitting the nozzle 40 to be matingly engaged with the main body of the vacuum head 36 as shown, for example, in FIGS. 7A and 7B. Thus, the nozzle 40 has a peripheral wall 49 with an outer annular wall surface that is of a substantially consistent diameter and an inner annular wall surface that tapers, frusto-conically toward the distal end of the nozzle 40 as shown perhaps most clearly in FIG. 9.

The base bevel surface 41 is formed as a mitered end of the nozzle 40. As noted, the base bevel surface 41 is, in this example, cut to an angle of 45 degrees. The base bevel surface 41 thus presents a substantially flat surface with the nozzle aperture 45 therewithin. Here, however, a groove, channel, or canal 47 is formed, as by cutting or some other method, into the central, distal end of the nozzle 40 as is shown most clearly in FIGS. 8 through 10. The canal 47 communicates from the outer wall surface to the inner wall surface of the peripheral wall 49 of the nozzle 40. Here, the canal 47 is generally aligned with a radius of the nozzle 40. The canal 47 thus presents a passageway or tunnel across the base bevel surface 41 at the very distal tip of the nozzle 40. The canal 47 has a first, outer end open to the outer surface of the peripheral wall 49 and the environment exterior to the nozzle 40 and a second, inner end open to the inner surface of the peripheral wall 49 and the nozzle aperture 45.

While other configurations would be possible and within the scope of the invention except as it might be expressly limited by the claims, the depicted canal 47 in the present embodiment has a substantially V-shaped cross section. The canal 47 can progressively widen and deepen from the outer wall surface to the inner wall surface of the nozzle 40. With that, the canal 47 acts as a passageway along the base bevel surface 41 and from the outer wall surface to the inner wall surface of the peripheral wall 49 of the nozzle 40. The canal 47 further facilitates and directs the flow of molten metal, gasses, and other heated matter within the nozzle 40. Particularly when combined with the introduction of cooling and vaporizing fluid as disclosed herein, overheating, material accumulation, and galling are sought to be prevented.

As noted previously, the vacuum nozzle 40 can be formed integrally with or separately from the vacuum head 36. The nozzle 40 can be formed from any suitable material or combination thereof. In certain embodiments, for instance, the vacuum nozzle 40 can be crafted from a high-melting point aluminum alloy.

Under this construction, the weld removal system 10 can be employed in cutting, gouging, and weld removal with the base bevel surface 41 resting on the surface of the work piece 100. The base bevel surface 41 can thus provide support to the welding head 12 and the adjustable vacuum and support system 25 thereby reducing operator fatigue, improving control over the disposition of the welding head 12 relative to the work surface 100, and, as a result, improving the quality of the welding process.

It has also been found that the relative positioning of the welding head 12, the vacuum head 36, and the vacuum nozzle 40 as disclosed herein relative to one another and relative to the surface of the work piece 100 can be exploited to a synergistic effect. The relative configurations and positioning can be dependent, in part, on the thickness of the work piece 100. For instance, using the system 10 disclosed herein, a worker was able to produce a clean gouge 102 in work pieces 100 of ⅜ to ⅝ inch steel plate with a gouge 102 of a depth of approximately ¼ inch and a width between 3/16 and 5/16 inches while travelling across the work piece 100 at a rate of roughly ¾ inches per second. To the knowledgeable observer, achieving such results is remarkable.

When the weld removal system 10 is used for weld removal, cutting, or gouging, the vacuum head 36 and nozzle 40 can be disposed at an angle N relative to the work piece 100, and the welding head 12 can be disposed at an angle T relative to the work piece 100 as shown, for instance, in FIG. 7A. Moreover, it has been found that advantageous results can be achieved by resting the proximal, shorter portion of the nozzle 40 on the surface of the work piece 100 while the distal end of the nozzle 40, which can include the bevel surface 43, is lifted off of the work piece 100 at a given angle Δ.

Under one embodiment of the nozzle 40 as disclosed herein, the angle Δ can be adjusted to produce a gap of approximately 3/32 inches between the distal end of the nozzle 40 and the surface of the work piece 100. Raising the distal edge of the nozzle 40 facilitates the intake of air. As the angle Δ is increased, the resulting gouge tends to become wider over a given range of angle Δ. Also, advancing the electrode 14 of the welding head 12 has been found to produce a deeper gouge. Further, it has been found that advancing the electrode 14 to produce a deeper gouge tends to demand a concomitant increase in the width of the gouge and thus the angle Δ. Additionally, a distance of approximately ⅝ inches between the nozzle 88 and the welding tip 14 has been found to produce advantageous cooling and preservation effects as disclosed herein.

The relative positioning of the welding head 12, the vacuum head 36, and the vacuum nozzle 40 as disclosed herein relative to one another and relative to the surface of the work piece 100 can vary depending on, among other things, the work piece 100. For instance, performance in relation to a thicker work piece 100 may be improved by adjusting the angles T and N of the welding head 12, the vacuum head 36, and the angle Δ of the bevel surface 41. The amperage of the welding head 12 can be adjusted as can be the flow of liquid, which can be in mist form or free flowing, or otherwise, through the nozzle 88. The shape and size of the canal 47 can also be varied to suit the application.

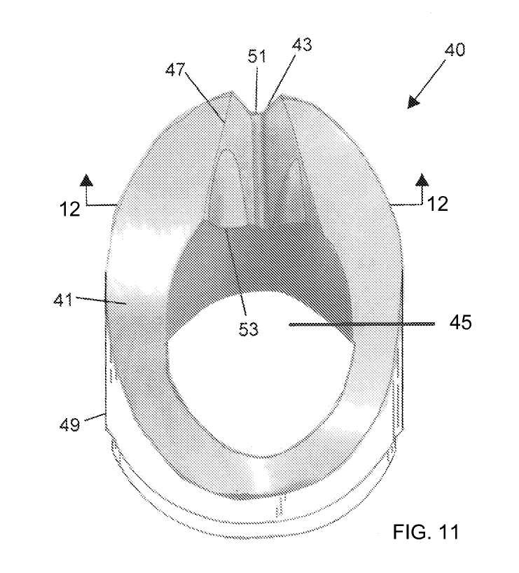

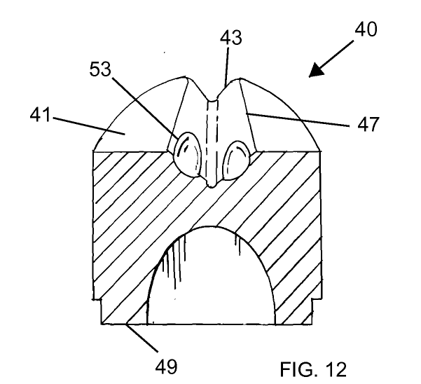

A further refined nozzle 40 is depicted in FIGS. 11 and 12. There, the nozzle again has a peripheral wall 49 with an outer wall surface and an inner wall surface. The nozzle 40 has a mitered end forming a base bevel surface 41. The base bevel surface 41 comprises a substantially flat surface with the nozzle aperture 45 therewithin. To prevent clogging, at least the inner surface of the peripheral wall 49 of the nozzle 40 tapers toward the distal end of the nozzle 40, such as in a frusto-conical pattern. Here, the outer surface of the peripheral wall 49 is cylindrical and of a generally consistent diameter, except for a proximal end portion of the nozzle 40 where the outer surface of the peripheral wall 49 narrows to a reduced diameter at a shoulder for permitting the nozzle 40 to be matingly engaged with the main body of the vacuum head 36 as shown, for example, in FIGS. 7A and 7B. Thus, the nozzle 40 has a peripheral wall 49 with an outer annular wall surface that is of a substantially consistent diameter and an inner annular wall surface that tapers, frusto-conically toward the distal end of the nozzle 40.

A groove, channel, or canal 47 is formed, as by cutting or some other method, into the central, distal end of the nozzle 40. The canal 47 communicates from the outer wall surface to the inner wall surface of the peripheral wall 49 of the nozzle 40. The canal 47 is again substantially aligned with a radius of the nozzle 40. The canal 47 thus presents a passageway or tunnel across the base bevel surface 41 at the very distal tip of the nozzle 40. The canal 47 has a first, outer end open to the outer surface of the peripheral wall 49 and the environment exterior to the nozzle 40 and a second, inner end open to the inner surface of the peripheral wall 49 and the nozzle aperture 45.

The canal 47 has a substantially V-shaped cross section established by first and second canal faces. The canal 47 can progressively widen and deepen from the outer wall surface to the inner wall surface of the nozzle 40 to act as a passageway along the base bevel surface 41 and from the outer wall surface to the inner wall surface of the peripheral wall 49 of the nozzle 40.

In the present embodiment, however, a concavity or supplemental depression 53 is formed in each face of the canal 47. Moreover, the base of the canal 47 where the faces of the canal 47 meet can be arcuate, such as by having a semi-circular cross section. The canal 47 further broadens in volume in the area of the depressions 53 formed in the faces of the canal 47. In this embodiment, the depressions 53 are arcuate in periphery and cross section. The depressions 53 can begin at a mid-portion of the faces of the canal 47 and are contiguous with the inner surface of the peripheral wall 49 and with the nozzle aperture 45. The depressions 53 can progressively deepen as the depressions 53 approach the inner surface of the peripheral wall 49 so that the depressions 53 have a greatest depth and volume at the inner surface of the peripheral wall 49. The depressions 53 can be identical, or they can vary. Moreover, it would be possible for just one depression 53 to be included, whether on one face of the canal 47 or, possibly, at the base of the canal 47. It would also be possible to have further depressions 53 in the canal 47 beyond the two illustrated. In any case, the depressions 53 so configured and intended to improve the performance of the nozzle 40 and the overall system 10 still further.

With certain details of the present invention for a system and method for use with a welding apparatus and method disclosed, it will be appreciated by one skilled in the art that changes and additions could be made thereto without deviating from the spirit or scope of the invention. This is particularly true when one bears in mind that the presently preferred embodiments merely exemplify the broader invention revealed herein. Accordingly, it will be clear that those with certain major features of the invention in mind could craft embodiments that incorporate those major features while not incorporating all of the features included in the preferred embodiments.

Therefore, the following claims are intended to define the scope of protection to be afforded to the inventor. Those claims shall be deemed to include equivalent constructions insofar as they do not depart from the spirit and scope of the invention. It must be further noted that a plurality of the following claims may express certain elements as means for performing a specific function, at times without the recital of structure or material. As the law demands, these claims shall be construed to cover not only the corresponding structure and material expressly described in this specification but also all equivalents thereof that might be now known or hereafter discovered.

I claim as deserving the protection of Letters Patent:

1. A metalworking system with the application of a vacuum during operation of a welding system to evacuate particulate matter, smoke, excess gasses, and molten metal from a work area during weld removal, cutting, and gouging, the metalworking system comprising:
a welding system with a welding head, an electrode holder retained by the welding head, an electrode retained by the electrode holder for creating a welding arc, and a welding power supply connected to the welding head;
a vacuum system with a vacuum head;
a mounting bracket for coupling the welding head to the vacuum head wherein the mounting bracket is adjustable to permit an adjustment of a disposition of the welding head in relation to the vacuum head; and
a liquid dispensing system retained to dispense liquid into the work area.

2. The metalworking system of claim 1 wherein the vacuum system further comprises a vacuum nozzle retained by the vacuum head wherein the vacuum nozzle has a nozzle aperture and a support surface for being rested on a surface of a workpiece during weld removal, cutting, and gouging whereby the vacuum nozzle can provide support to the vacuum head and the welding head and whereby a height and supported position of the electrode above the surface of the workpiece can be adjusted by use of the mounting bracket to adjust a disposition of the welding head in relation to the vacuum head.

3. The metalworking system of claim 2 wherein the vacuum nozzle has an inner wall surface that tapers toward a distal end of the vacuum nozzle.

4. The metalworking system of claim 1 wherein the liquid dispensing system comprises a liquid dispensing nozzle retained to dispense liquid into the work area.

5. The metalworking system of claim 4 wherein the liquid dispensing system further comprises a reservoir with an open inner volume for retaining a volume of liquid wherein the reservoir is in fluidic communication with the liquid dispensing nozzle.

6. The metalworking system of claim 1 wherein the liquid dispensing system comprises a mist generator operative to create a mist from supplied liquid to be dispensed into the work area.

7. The metalworking system of claim 6 wherein the liquid dispensing system further comprises a reservoir with an open inner volume for retaining a volume of liquid wherein the reservoir is in fluidic communication with the mist generator.

8. The metalworking system of claim 7 wherein the mist generator comprises a Venturi tube operative to generate a mist from liquid under the Venturi effect.

9. The metalworking system of claim 8 further comprising a compressed air source for supplying compressed air to the mist generator.

10. The metalworking system of claim 1 wherein the liquid dispensing system comprises a liquid dispensing nozzle retained to dispense liquid into the work area and wherein the liquid dispensing nozzle is adjustable in position relative to the work area.

11. The metalworking system of claim 1 wherein the vacuum system further comprises a vacuum nozzle retained by the vacuum head wherein the vacuum nozzle has a peripheral wall with an outer wall surface, an inner wall surface, a nozzle aperture at least partially defined by the inner wall surface, a support surface for being rested on a surface of a workpiece during weld removal, cutting, and gouging, and a canal in the support surface.

12. The metalworking system of claim 11 wherein the canal communicates from a first end open to the outer wall surface of the peripheral wall and a second end open to the inner wall surface of the peripheral wall.

13. The metalworking system of claim 11 wherein the canal has a V-shape with first and second canal faces.

14. The metalworking system of claim 13 further comprising at least one depression in at least one of the canal faces.

15. The metalworking system of claim 14 wherein there is a depression in each of the first and second canal faces.

16. The metalworking system of claim 1 wherein the vacuum system further comprises a source of negative air pressure connected to the vacuum head by a conduit.

17. A method for metalworking with a supply of liquid and an application of a vacuum during operation of a welding arrangement to evacuate particulate matter, smoke, gas, and molten metal from a work area, the method for metalworking comprising:
providing a welding system with a welding head, an electrode holder retained by the welding head, an electrode retained by the electrode holder for creating a welding arc, and a welding power supply connected to the welding head;
providing a vacuum system with a vacuum head;
providing a mounting bracket for coupling the welding head to the vacuum head wherein the mounting bracket is adjustable to permit an adjustment of a disposition of the welding head in relation to the vacuum head;
providing a liquid dispensing system retained to dispense liquid into the work area;
disposing the vacuum head and the welding head on or in proximity to the workpiece;
cutting, gouging, or removing welding from the workpiece by actuating the electrode of the welding arrangement while evacuating particulate matter, smoke, gas, and molten metal through the vacuum nozzle by actuating the vacuum system; and
dispensing liquid to the work area defined by the vacuum nozzle and the welding head by use of the liquid dispensing system.

18. The method for metalworking of claim 17 wherein the welding system comprises a tungsten inert gas (TIG) welding system with a nonconsumable tungsten electrode and an inert gas supply for providing shielding gas during metalworking.

19. The method for metalworking of claim 17 wherein the vacuum system further comprises a vacuum nozzle retained by the vacuum head wherein the vacuum nozzle has a nozzle aperture and a support surface and further comprising the step of resting the support surface on a surface of a workpiece during weld removal, cutting, and gouging whereby the vacuum nozzle provides support to the vacuum head and the welding head and whereby a height and supported position of the electrode above the surface of the workpiece can be adjusted by use of the mounting bracket to adjust a disposition of the welding head in relation to the vacuum head.

20. The method for metalworking of claim 17 wherein the liquid dispensing system comprises a liquid dispensing nozzle retained to dispense liquid into the work area and wherein the step of dispensing liquid comprises dispensing liquid from the dispensing nozzle.

21. The method for metalworking of claim 20 wherein the liquid dispensing system further comprises a reservoir with an open inner volume retaining a volume of liquid, wherein the reservoir is in fluidic communication with the liquid dispensing nozzle, and wherein the step of dispensing liquid from the dispensing nozzle includes receiving liquid from the reservoir.

22. The method for metalworking of claim 17 wherein the liquid dispensing system comprises a mist generator operative to create a mist from supplied liquid.

23. The method for metalworking of claim 17 wherein the step of dispensing liquid comprises dispensing liquid at least partially in mist form.

24. The method for metalworking of claim 17 wherein the vacuum system further comprises a vacuum nozzle retained by the vacuum head wherein the vacuum nozzle has a peripheral wall with an outer wall surface, an inner wall surface, a nozzle aperture at least partially defined by the inner wall surface, and a support surface for being rested on a surface of a workpiece during weld removal, cutting, and gouging, and a canal in the support surface and further comprising the step of resting the support surface on a surface of a workpiece during weld removal, cutting, and gouging.

25. The method for metalworking of claim 24 wherein the canal communicates from a first end open to the outer wall surface of the peripheral wall and a second end open to the inner wall surface of the peripheral wall.

26. The method for metalworking of claim 25 wherein the canal has a V-shape with first and second canal faces.

27. The method for metalworking system of claim 26 further comprising at least one depression in at least one of the canal faces.

28. A metalworking system with the application of a vacuum during operation of a welding system with a welding head to evacuate particulate matter, smoke, excess gasses, and molten metal from a work area during weld removal, cutting, and gouging, the metalworking system comprising:
a vacuum system with a vacuum head and a vacuum nozzle retained by the vacuum head wherein the vacuum nozzle has a peripheral wall with an outer wall surface, an inner wall surface, a nozzle aperture at least partially defined by the inner wall surface, and a support surface for being rested on a surface of a workpiece during weld removal, cutting, and gouging;
a canal in the support surface of the vacuum nozzle; and
a mounting bracket for coupling the welding head of the welding system to the vacuum head.

29. The metalworking system of claim 28 further comprising a welding system with a welding head, an electrode holder retained by the welding head, an electrode retained by the electrode holder for creating a welding arc, and a welding power supply connected to the welding head.

30. The metalworking system of claim 28 wherein the mounting bracket is adjustable to permit an adjustment of a disposition of the welding head in relation to the vacuum head

31. The metalworking system of claim 28 wherein the canal communicates from a first end open to the outer wall surface of the peripheral wall and a second end open to the inner wall surface of the peripheral wall.

32. The metalworking system of claim 28 wherein the canal has a V-shape with first and second canal faces.

33. The metalworking system of claim 32 further comprising at least one depression in at least one of the canal faces.

34. The metalworking system of claim 33 wherein there is a depression in each of the first and second canal faces.

35. The metalworking system of claim 28 wherein the vacuum system further comprises a source of negative air pressure connected to the vacuum head by a conduit.

36. The metalworking system of claim 35 wherein the vacuum nozzle has an inner annular wall surface that tapers toward a distal end of the vacuum nozzle.

37. The metalworking system of claim 28 further comprising a liquid dispensing system retained to dispense liquid into the work area.

38. The metalworking system of claim 37 wherein the liquid dispensing system comprises a liquid dispensing nozzle retained to dispense liquid into the work area.

39. The metalworking system of claim 38 wherein the liquid dispensing system further comprises a reservoir with an open inner volume for retaining a volume of liquid wherein the reservoir is in fluidic communication with the liquid dispensing nozzle.

40. The metalworking system of claim 37 wherein the liquid dispensing system comprises a mist generator operative to create a mist from supplied liquid.
